(19) United States
(12) Patent Application Publication
(10) Pub. No.: US 2023/0198080 A1
(43) Pub. Date: Jun. 22, 2023

(54) ENERGY STORAGE SYSTEM

(71) Applicant: Commissariat à l'énergie atomique et aux énergies alternatives, Paris (FR)

(72) Inventor: Jérémy MARTIN, Grenoble Cedex 09 (FR)

(73) Assignee: Commissariat à l'énergie atomique et aux énergies alternatives, Paris (FR)

(21) Appl. No.: 18/067,907

(22) Filed: Dec. 19, 2022

(30) Foreign Application Priority Data
Dec. 22, 2021 (FR) 2114249

(51) Int. Cl. H01M 50/296; H01M 50/51; H01M 50/227; H01M 8/24; H01M 50/224; H01M 8/0202; C25B 9/70; C25B 9/65

(52) U.S. Cl. CPC H01M 50/296; C25B 9/65; C25B 9/70; H01M 8/24; H01M 8/0202; H01M 50/51; H01M 50/224; H01M 50/227

(57) ABSTRACT

The present invention relates to an energy storage system (10) comprising a plurality of electrical module packs (12) connected in series, each electrical module pack (12) having a positive terminal and a negative terminal, the voltage at the terminals of each electrical module pack (12) being equal to the potential difference between the positive terminal and the negative terminal of the pack (12), the voltage at the terminals of the system (10) being equal to the sum of the voltages of the connected electrical module packs (12), each electrical module pack (12) being supported by a frame (20), each frame (20) being set at a reference potential, characterized in that the reference potential of each frame (20) is broadly between the positive terminal potential and the negative terminal potential of the electrical module pack (12) supported by the frame.

### TECHNICAL FIELD OF THE INVENTION

The present invention relates to an energy storage system.

### BACKGROUND OF THE INVENTION

Commercially available energy storage systems are mostly low-voltage systems comprising a plurality of batteries connected in series to form a battery pack. The terminal voltage of an energy storage system is the potential difference between the positive and negative terminal of the system. In particular, FIG. 1 shows an example of a low voltage energy storage system delivering a maximum voltage of around 1500 Volts (V).

The battery pack in such systems is supported by a frame connected to the ground (also called ground or 0 volt reference). In order to meet insulation requirements, the voltage between the positive terminal and the ground on the one hand, and between the negative terminal and the ground on the other hand, should be much lower than the insulation voltage of the system. The insulation voltage is usually defined in rms for one minute (RMS - 1 minute) as twice the maximum voltage plus 1000 V. In the case of FIG. 1, the insulation voltage is 4000 Volts, so the voltage between the positive terminal and the ground is +750 Volts, and the voltage between the negative terminal and the ground is -750 Volts. Thus, even if there is a short circuit on one of the terminals, the absolute value of the voltage between the other terminal and the ground is at most 1500 Volts and remains much lower than the insulation voltage of 4000 Volts.

If the aim is to increase the voltage of such energy storage systems (increase the voltage between the positive and negative terminal of the system), it is natural to connect a plurality of storage systems in series, i.e. a plurality of battery packs in series. Such a configuration is illustrated in FIG. 2, where two battery packs corresponding to the one in FIG. 1 have been connected in series. The maximum voltage reached for the system is then 3000 Volts.

Nevertheless, in normal operation, the voltage between each system terminal and the ground reaches the maximum voltage, 1500 Volts for the configuration in FIG. 2. Also, in the presence of a short circuit on one of the terminals, the absolute value of the voltage between the other terminal and the ground reaches the maximum voltage, 3000 Volts for FIG. 2, and thus exceeds the voltage for which the insulation has been designed for a single pack system.

### SUMMARY OF THE INVENTION

There is therefore a need for an energy storage system that can increase the voltage in commercially available storage systems while respecting insulation constraints.

To this end, the present description relates to an energy storage system comprising a plurality of electrical module packs connected in series, each electrical module pack having a positive terminal and a negative terminal, the voltage at the terminals of each electrical module pack being equal to the potential difference between the positive terminal and the negative terminal of the pack, the terminal voltage of the system being equal to the sum of the voltages of the connected electrical module packs, each battery pack being supported by a frame, each frame being set at a reference potential, the reference potential of each frame being broadly between the potential of the positive terminal and the potential of the negative terminal of the electrical module pack supported by the frame.

In particular embodiments, the system comprises one or more of the following features, in isolation or in any technically possible combination:
each electrical module is a battery;
each electrical module is an electrolyser module or a fuel cell module;
the absolute value of the potential difference between, on the one hand, the potential of each terminal of each pack and, on the other hand, the potential of the frame supporting the pack, is equal to 0 Volts or to the terminal voltage of the pack;
the reference potential of at least one of the frames is different from the ground potential;
each frame comprises a conductive shield to which the reference potential is applied;
each frame comprises an additional terminal to which a voltage corresponding to the reference potential is applied for setting the frame to the reference potential;
each frame is connected to the positive or negative pole of the corresponding electrical module pack for setting the frame to the reference potential;
the system comprises a casing encapsulating the plurality of electrical module packs;
the casing is made of plastic;
the casing is metallic and grounded, the casing being further connected to each frame by at least one insulator;
the voltages at the terminals of the electrical module packs are identical, e.g. equal to 1500 Volts;
the voltage at the terminals of the system is strictly greater than 1500 Volts, preferably greater than or equal to 3000 Volts.

### BRIEF DESCRIPTION OF THE DRAWINGS

Other features and advantages of the invention will become apparent from the following description of embodiments of the invention, given by way of example only and with reference to the drawings, which are:

FIG. 1, a schematic view of an example of a prior art energy storage system formed by a battery pack,

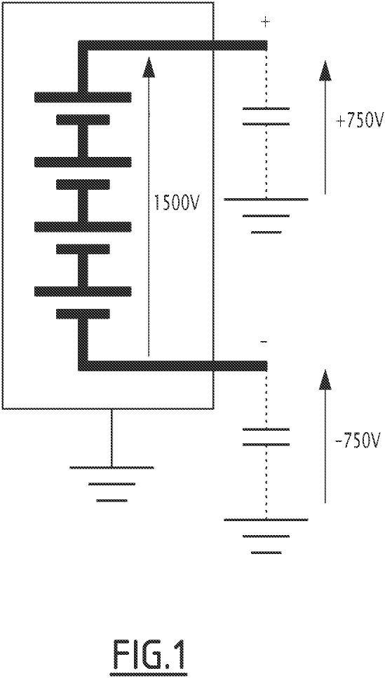

FIG. 2, a schematic view of an example of an energy storage system performing an increase in voltage by connecting two battery packs of FIG. 1, the issues relating to such a system having been set out in the introductory part of the description,

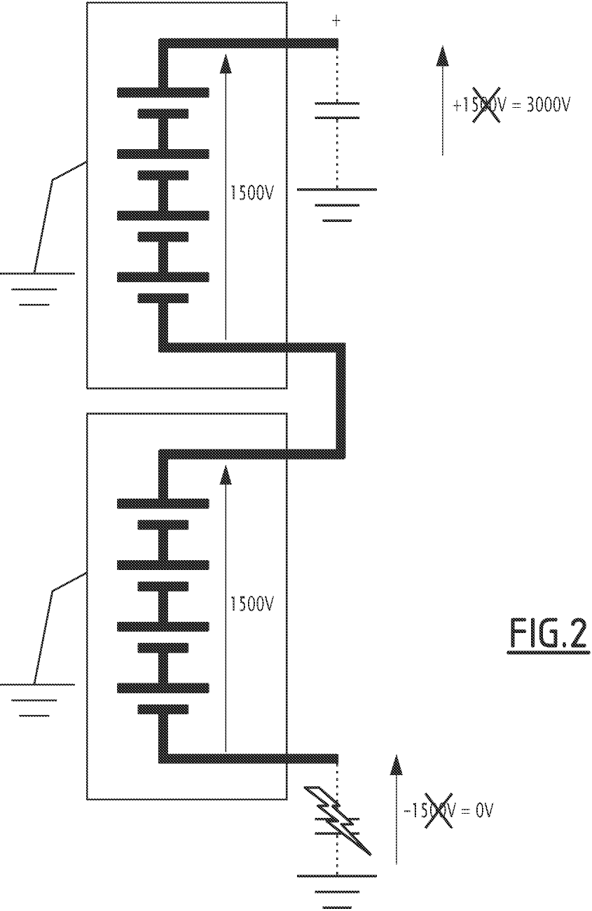

FIG. 3, an example of an energy storage system that solves the problem outlined in the introductory part of the description,

FIG. 4, another example of an energy storage system that solves the problem outlined in the introductory part of the description, and

FIG. 5, yet another example of an energy storage system that solves the problem outlined in the introductory part of the description.

### DETAILED DESCRIPTION OF SOME EMBODIMENTS

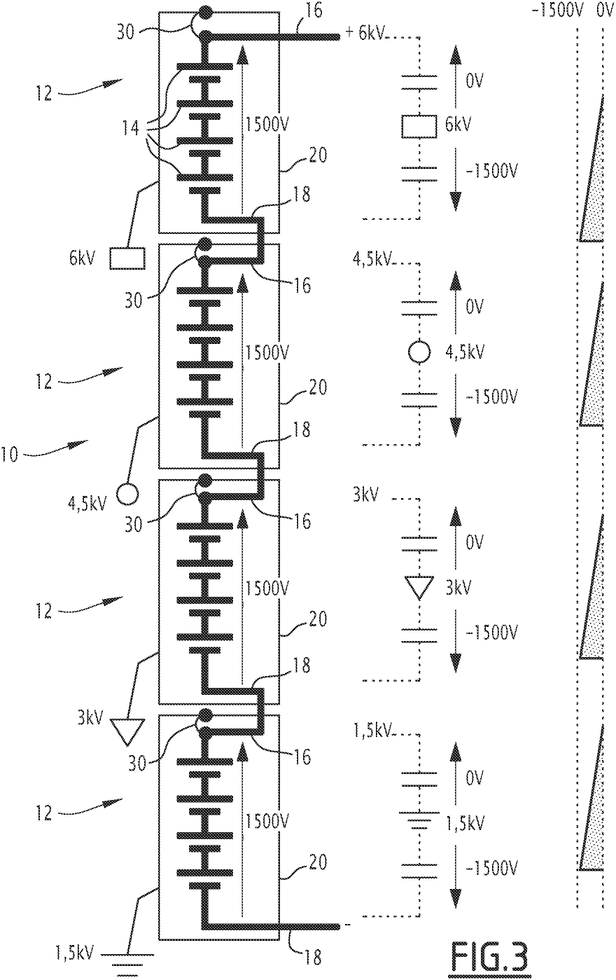

An energy storage system 10 that achieves a voltage increase over the commercially available storage systems described in the introduction, while meeting the insulation constraints, is described in the following. FIGS. 3 to 5 are examples of such a system 10, and will be described in detail in due course in the description.

In particular, the system 10 is intended to be integrated into installations performing an energy storage action, such as solar photovoltaic power plants.

The system 10 comprises a number of battery packs 12 connected in series. The connection is typically made by joining together the positive terminal of one pack 12 with the negative terminal of another pack 12, and so on depending on the number of packs 12.

A plurality of battery packs 12 is understood to mean that at least two battery packs 12 are connected in series. In the examples of FIGS. 3 to 5, four battery packs 12 are connected in series. The number of battery packs 12 connected in series is not limited to four, however, and is greater or less than four depending on the final voltage to be achieved.

Each battery pack 12 is typically a low voltage battery pack, such as a standard commercially available battery pack. For example, the maximum terminal voltage of such a battery pack is 1500 Volts or less.

Each battery pack 12 consists of a plurality of batteries 14 connected in series (shown only in one of the battery packs 12 in FIGS. 3 to 5 so as not to overwhelm the figures). The batteries are, for example, lithium-ion batteries.

Each battery pack 12 has a positive terminal and a negative terminal, forming positive and negative intermediate terminals 16 and 18, respectively, of the storage system 10. The terminal voltage of each battery pack 12 is equal to the potential difference between the positive terminal and the negative terminal of the pack 12. In the examples of FIGS. 3 to 5, the terminal voltage of each pack 12 is 1500 Volts.

The battery packs 12 are typically connected to each other in a connection order. The negative terminal of the first battery pack 12 in the connection order is the negative terminal of the system 10. The positive terminal of the last battery pack 12 in the connection order is the positive terminal of the system 10. The terminal voltage of the storage system 10 is thus equal to the sum of the voltages of the connected battery packs 12. Thus, the terminal voltage of the system 10 is typically strictly greater than 1500 Volts, preferably greater than or equal to 3000 Volts. In the examples in FIGS. 3 to 5, four 1500 volt battery packs 12 are connected in series, and therefore the voltage of the system 10 is 6000 Volts. The connection is made from the lowest battery pack 12 in the figures to the highest battery pack 12 in the figures.

Each battery pack 12 is supported by a frame 20, also called a support or a rack.

Each frame 20 is set to a reference potential. The reference potential of each frame 20 is broadly between the potential of the positive terminal and the potential of the negative terminal of the corresponding battery pack 12. Thus, the setting of the potential of the frame 20 is, for example, achieved by connecting the frame 20 to one of the batteries contained in the battery pack 12.

In a preferred embodiment, the reference potential of each frame 20 is equal to the potential of the positive or negative terminal of the corresponding battery pack 12. This facilitates the design of the storage system 10.

Thus, in this preferred mode, in normal operation (i.e. in the absence of a short circuit), the potential difference (voltage) between, on the one hand, the potential of the terminal of each pack 12 which is equal to the reference potential, and on the other hand, the corresponding reference potential, is zero. Furthermore, the absolute value of the potential difference between the potential of the other terminal of each pack 12 and the reference potential is equal to the voltage of the pack 12. Thus, even in the presence of a short circuit on one of the terminals of the system 10, the absolute value of the voltage between the other terminal and the reference potential of the pack 12 is at most equal to the voltage of the pack 12, which remains in accordance with the insulation voltage.

In the examples of FIGS. 3 to 5, the reference potential of each frame 20 is equal to the potential of the positive terminal of the pack 12 supported by the frame 20, i.e. 1500 V for the first frame 20, 3000 V for the second frame 20, 4500 V for the third frame 20 and 6000 V for the fourth frame 20. Thus, the potential difference between the positive terminal of each pack 12 and the corresponding reference potential is equal to 0 V. The potential difference between the negative terminal of each pack 12 and the corresponding reference potential is equal to -1500 V (1500 V being the pack voltage).

It should be noted that in these examples, if the reference potential of each frame 20 had been that of the negative terminal of the corresponding pack 12, the potential difference between the positive terminal of each pack 12 and the corresponding reference potential would be equal to +1500 V. The potential difference between the negative terminal of each pack 12 and the corresponding reference potential would be 0 V.

Generally, as the system 10 comprises at least two battery packs 12 connected in series, the frame 20 of one of the packs 12 is set to a reference potential which is different from the ground potential (i.e. 0 V potential). The reference potential of the frames 20 therefore increases as the packs 12 are connected.

Advantageously, each frame 20 comprises a conductive shield to which the reference potential is applied.

In one embodiment, each frame 20 comprises an additional terminal to which a voltage corresponding to the reference potential is applied for setting the frame 20 to the reference potential. For example, the additional terminal projects from the frame 20.

In another embodiment, each frame 20 is connected to the positive pole or negative pole of the corresponding battery pack 12 for setting the frame 20 to reference potential. The connection is, for example, made by a potential setting connector 30, such as a metal braid. Such a connection is illustrated in FIGS. 3 to 5.

Optionally, the system 10 comprises a casing 40 encapsulating the plurality of battery packs 12. The casing 40 is suitable for protecting the battery packs 12, and provides a system 10 with no live bare parts.

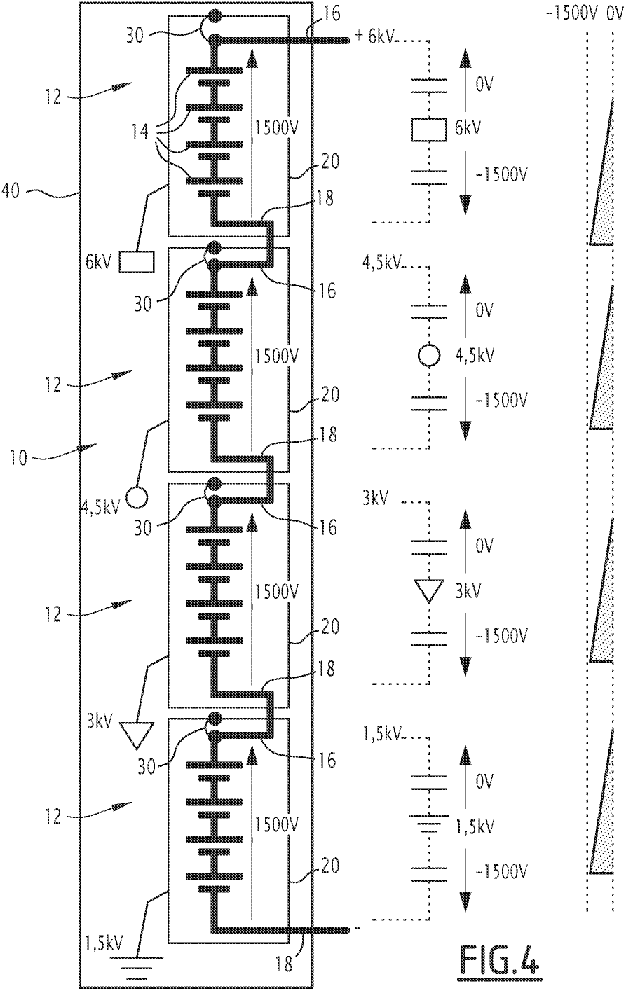

In the example shown in FIG. 4, the casing 40 is made of plastic.

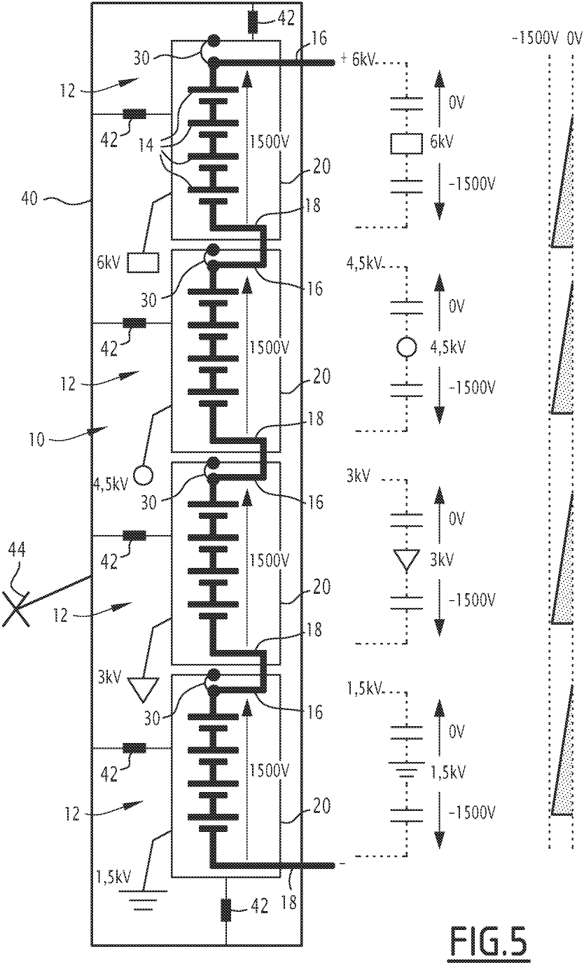

In the example shown in FIG. 5, the casing 40 is metallic and is connected to each frame 20 by at least one insulator 42. The casing 40 is in this case connected to the ground 44. An insulator is an electrotechnical component made of an insulating material. A metal casing has the advantage of being more resistant than a plastic casing.

An example of the design of system 10 will now be described.

Initially, a plurality of (at least two) battery packs 12 are obtained to be connected, each pack 12 being supported by a frame 20.

One of the packs 12 is taken as the first pack for connection. The reference potential of the frame 20 of the first pack 12 is then set to a potential which is broadly between the potential of the positive terminal and the potential of the negative terminal of the first pack 12. Preferably, the reference potential of the frame 20 of the first pack 12 is equal to the potential of the positive terminal or the potential of the negative terminal of the first pack 12.

Then, a second pack 12 is connected to the first pack 12, for example by connecting the negative terminal of the second pack 12 to the positive terminal of the first pack 12. The reference potential of the frame 20 of the second pack 12 is then set to a potential broadly between the potential of the positive terminal and the potential of the negative terminal of the second pack 12. Preferably, the reference potential of the frame 20 of the second pack 12 is equal to the potential of the positive terminal or the potential of the negative terminal of the second pack 12. This is then repeated for each further pack 12 to be connected.

In this way, the energy storage system 10 allows a voltage increase to be achieved from low voltage storage systems such as those on the market, while respecting the insulation constraints but without introducing reinforced insulation. Indeed, the insulation is supported by the frame 20 of each battery pack. In particular, fixing the potentials of the frames 20 according to the corresponding pack (potential included in the broad sense between the potentials of the positive and negative terminals) makes it possible not to exceed the insulation voltage even in the event of a short-circuit.

Such a system 10 also eliminates positive common mode potentials. Maintenance is also facilitated (grounding).

A person skilled in the art will appreciate that the embodiments and variants described above can be combined to form new embodiments, provided that they are technically compatible.

It should be noted that in the example of FIGS. 3 to 5, the terminal voltages of the battery packs 12 are identical (equal to 1500 Volts). Nevertheless, the present invention also applies to the case of battery packs 12 of different voltages, for example, for a connection of a battery pack 12 having a maximum voltage around 1500 V to a battery pack 12 having a maximum voltage around 500 V.

In addition, it is emphasised that the invention has been described using battery packs as an example. Nevertheless, the principle of the invention applies to all types of electrical modules, and in particular also to electrolyser modules or fuel cell modules. Indeed, in the case of electrochemical reactors such as electrolyzers or fuel cells, large series of components can create safety and insulation problems, which the proposed storage system makes it possible to solve. The present description can therefore be read by replacing the term “battery” with the term “electrical module”, and more particularly “electrolyser module” or “fuel cell module”.

1. Energy storage system comprising a plurality of electrical module packs connected in series, each electrical module pack having a positive terminal and a negative terminal, the voltage at the terminals of each electrical module pack being equal to the potential difference between the positive terminal and the negative terminal of the pack, the voltage at the terminals of the system being equal to the sum of the voltages of the connected electrical module packs, each electrical module pack being supported by a frame, each frame being set at a reference potential, characterized in that the reference potential of each frame is broadly between the positive terminal potential and the negative terminal potential of the electrical module pack supported by the frame.

2. System according to claim 1, wherein each electrical module is a battery.

3. System according to claim 1, wherein each electrical module is an electrolyser module or a fuel cell module.

4. System according to claim 1, wherein the absolute value of the potential difference between, on the one hand, the potential of each terminal of each pack and, on the other hand, the potential of the frame supporting the pack, is equal to 0 Volts or to the voltage at the terminals of the pack.

5. System according to claim 1, wherein the reference potential of at least one of the frames is different from the ground potential.

6. System according to claim 1, wherein each frame comprises a conductive shield to which the reference potential is applied.

7. System according to claim 1, wherein each frame comprises an additional terminal to which a voltage corresponding to the reference potential is applied for setting the frame to the reference potential.

8. System according to claim 1, wherein each frame is connected to the positive pole or negative pole of the corresponding electrical module pack for setting the frame to the reference potential.

9. System according to claim 1, wherein the system comprises a casing encapsulating the plurality of electrical module packs.

10. System according to claim 9, wherein the casing is made of plastic.

11. System according to claim 9, wherein the casing is metallic and grounded, the casing being further connected to each frame by at least one insulator.

12. System according to claim 1, wherein the voltages at the terminals of the electrical module packs are identical.

13. System according to claim 1, wherein the voltages at the terminals of the electrical module packs are equal to 1500 Volts.

14. System according to claim 1, wherein the voltage at the terminals of the system is strictly greater than 1500 Volts.

15. System according to claim 1, wherein the voltage at the terminals of the system is strictly greater than or equal to 3000 Volts.
